(19) United States
(12) Patent Application Publication
(10) Pub. No.: US 2019/0203778 A1
(43) Pub. Date: Jul. 4, 2019

(54) MOTOR HAVING CLUTCH FUNCTION

(71) Applicant: REALGAM CO., LTD., Seongnam-Si, Gyeonggi-do (KR)

(72) Inventors: Bok Sung Oh, Anyang-Si (KR); Yun Ho Lee, Anyang-Si (KR); Yon Woo Chung, Seoul (KR)

(73) Assignee: REALGAM CO., LTD., Seongnam-Si, Gyeonggi-do (KR)

(21) Appl. No.: 16/311,072

(22) PCT Filed: Jul. 2, 2018
(86) PCT No.: PCT/KR2018/007454

§ 371 Date: Dec. 18, 2018

(30) Foreign Application Priority Data
Dec. 28, 2017 (KR) 10-2017-0182688

(51) Int. Cl. F16D 15/00; F16D 27/00

(52) U.S. Cl. CPC F16D 15/00; F16D 48/06; F16D 27/004

(57) ABSTRACT

Disclosed is a motor having a clutch function. The motor having the clutch function includes a driving unit, a reduction gear unit configured to reduce a rotational speed of the driving unit, and a clutch unit connected between the driving unit and the reduction gear unit and configured to selectively block power transmission, and the clutch unit includes an inner race connected to the driving unit and having a clutch shell; an outer race configured to output a torque of the clutch shell; a plurality of rollers provided in a circumferential direction between the clutch shell and the outer race, and configured to transmit the torque; an armature configured to rotate with maintaining an interval between the plurality of rollers; and a solenoid configured to block the torque input from the outer race to the inner race by controlling the rotation of the armature.

### TECHNICAL FIELD

An example embodiment relates to a motor having a clutch function, and more particularly, to a motor having a clutch function that may transmit or block power depending on necessity.

### RELATED ART

As is well known, a motor refers to a device that converts electrical energy to mechanical energy and is widely used in the art for mechanical and electrical engineering.

In recent years, technology for virtual reality regarding an interface between a human and a computer by creating a specific environment or situation using the computer and making a user of the computer feel as if the user interacts with an actual surrounding situation or environment is widely being developed.

In the related art, disclosed is Korean Patent Laid-Open Publication No. 10-2009-0014321, published on Feb. 10, 2009, titled “virtual reality based haptic system”.

However, when the related art is applied to wearable devices worn around or attached to a body to be available, force feedback may be provided to a user by driving a motor having a reduction gear. In an opposite case, it is inconvenient for use and a sense of touch is degraded since the user needs to move a reducer of the motor by applying a force when the user moves.

### DETAILED DESCRIPTION

### Objectives

An example embodiment provides a motor having a clutch function that may transmit power to a user through driving of a driving unit or conversely block transmission of the power when the user moves.

### Solutions

A motor having a clutch function according to an example embodiment is described.

The motor having the clutch function includes a driving unit; a reduction gear unit configured to reduce a rotational speed of the driving unit; and a clutch unit connected between the driving unit and the reduction gear unit and configured to selectively block power transmission therebetween. The clutch unit includes an inner race connected to the driving unit and having a clutch shell; an outer race configured to output a torque of the clutch shell; a plurality of rollers provided in a circumferential direction between the clutch shell and the outer race, and configured to transmit the torque; an armature configured to rotate with maintaining an interval between the plurality of rollers; and a solenoid configured to block the torque input from the outer race to the inner race by controlling the rotation of the armature.

According to an aspect, the inner race may include a drive pinion configured to connect to the driving unit, and the outer race may include a driven pinion configured to connect to the reduction gear unit.

According to an aspect, the inner race may include a sleeve rotatably provided along outer circumference of a clutch shaft fastened to a housing configured to receive the clutch unit; and the clutch shell configured to rotate with a drive pinion that is provided on one side of the sleeve and configured to connect to the driving unit and a drive pinion that is provided on another side of the sleeve. The armature is rotatably provided along outer circumference of the sleeve to be adjacent to the clutch shell, and the solenoid may be configured to insert into the outer circumference of the sleeve to be adjacent to the armature and to fasten to the housing.

According to an aspect, the clutch shell may be in a polygonal plate shape having a contact surface to correspond to and contact the plurality of rollers, and the contact surface may include a curved surface that is curved inward to form a gap with outer circumference of the roller.

According to an aspect, the armature may further include a retainer configured to maintain the interval between the plurality of rollers.

According to an aspect, the clutch unit may further include a permanent magnet provided to the solenoid and configured to change a torque transmission state of the plurality of rollers to transmit the torque to the outer race by controlling the rotation of the armature in response to initially driving the driving unit.

A motor includes a driving unit; a reduction gear unit configured to reduce a rotational speed of the driving unit; and a clutch unit having an armature to be connected between the driving unit and the reduction gear unit and to selectively block power transmission therebetween. When a torque input to the clutch unit through the reduction gear unit is greater than a torque output from the driving unit, the torque input to the clutch unit through the reduction gear unit is blocked by controlling a torque of the armature.

According to an aspect, the driving unit is suspended at the same time of controlling the torque of the armature.

According to an aspect, the torque of the armature is controlled with a force greater than the torque of the driving unit in the case of controlling the torque of the armature.

According to an aspect, the driving unit is reversely rotated in the case of controlling the torque of the armature.

According to an aspect, the clutch unit may include an inner race connected to the driving unit and having a clutch shell; an outer race configured to output a torque of the clutch shell; a plurality of rollers provided in a circumferential direction between the clutch shell and the outer race, and configured to transmit the torque; the armature configured to rotate with maintaining an interval between the plurality of rollers; and a solenoid configured to change a torque transmission state of the plurality of rollers by controlling the rotation of the armature.

According to an aspect, the inner race may include a drive pinion configured to connect to the driving unit, and the outer race may include a driven pinion configured to connect to the reduction gear unit.

According to an aspect, the inner race may include a sleeve rotatably provided along outer circumference of a clutch shaft fastened to a housing configured to receive the clutch unit; and a clutch shell configured to rotate with a drive pinion that is provided on one side of the sleeve and configured to connect to the driving unit and a drive pinion that is provided on another side of the sleeve. The armature may be rotatably provided along outer circumference of the sleeve to be adjacent to the clutch shell, and the solenoid may be configured to insert into the outer circumference of the sleeve to be adjacent to the armature and to fasten to the housing.

According to an aspect, the clutch shell may be in a polygonal plate shape having a contact surface to correspond to and contact the plurality of rollers, and the contact surface may include a curved surface that is curved inward to form a gap with outer circumference of the roller.

According to an aspect, the armature may further include a retainer configured to maintain the interval between the plurality of rollers.

According to an aspect, the clutch unit may further include a permanent magnet provided to the solenoid and configured to change a torque transmission state of the plurality of rollers to transmit the torque to the outer race by controlling the rotation of the armature in response to initially driving the driving unit.

### Effect

According to the example embodiments, it is possible to transmit power to a user through driving of a driving unit and conversely, to prevent the power from being transmitted to the driving unit by way of a clutch unit when the user moves.

### BRIEF DESCRIPTION OF DRAWINGS

FIG. 1 is a perspective view of an assembly of a motor according to an example embodiment.

FIG. 2 is an exploded perspective view of a motor according to an example embodiment.

FIG. 3 is a cross-sectional view of the motor cut along line A-A of FIG. 1.

FIG. 4 is an enlarged cross-sectional view of a clutch unit according to an example embodiment.

FIG. 5 is a cross-sectional view of a roller in a wedge state, cut along line B-B of FIG. 4.

FIG. 6 is an enlarged view of a portion ‘C’ of FIG. 5 according to an example embodiment.

FIG. 7 is a cross-sectional view of a roller in an idle state, cut along line B-B of FIG. 4 according to an example embodiment.

FIG. 8 is an enlarged view of a portion ‘D’ of FIG. 7 according to an example embodiment.

FIG. 9 is an enlarged cross-sectional view of a clutch unit according to another example embodiment.

FIG. 10 is an enlarged perspective view of a solenoid according to another example embodiment.

### BEST MODE

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

Terms, such as first, second, A, B, (a), (b), and the like, may be used herein to describe components. Each of these terminologies is not used to define an essence, order or sequence of a corresponding component but used merely to distinguish the corresponding component from other components. It should be noted that if it is described that one component is “connected”, “coupled”, or “joined” to another component, a third component may be “connected”, “coupled”, and “joined” between the first and second components, although the first component may be directly connected, coupled, or joined to the second component.

A component included in a single example embodiment and a component including a common function are described using the same name in another example embodiment. Unless described otherwise, description made in one example embodiment may be applicable to the other example embodiment and a detailed description in the repeated range is omitted.

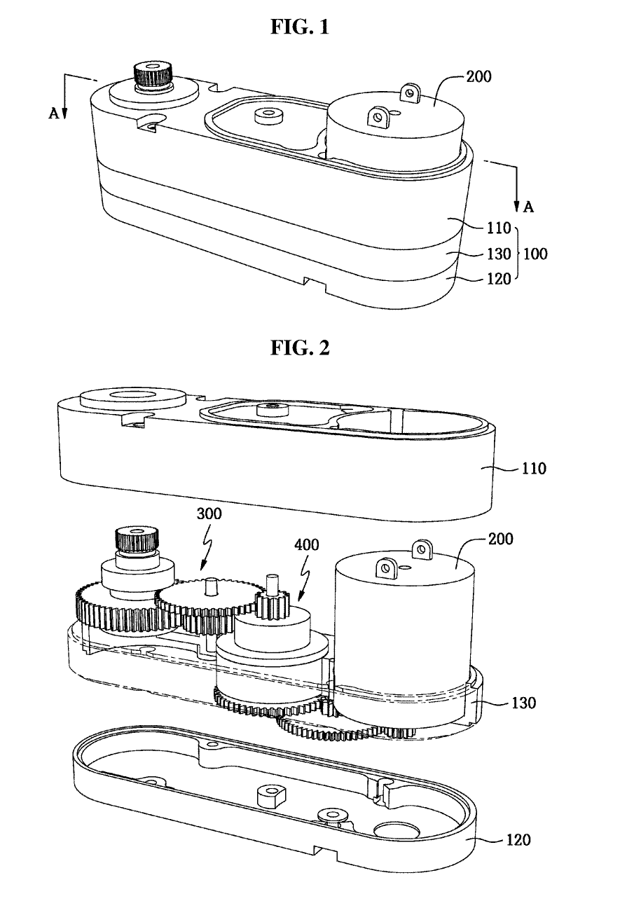

A motor having a clutch function according to an example embodiment may be applied to wearable interface devices attached to or worn by a body. The motor having the clutch function may provide a user with force feedback by a driving unit and may prevent an external force by a motion of the user from being transmitted to the driving unit. Hereinafter, the motor having the clutch function will be described with reference to FIGS. 1 to 10.

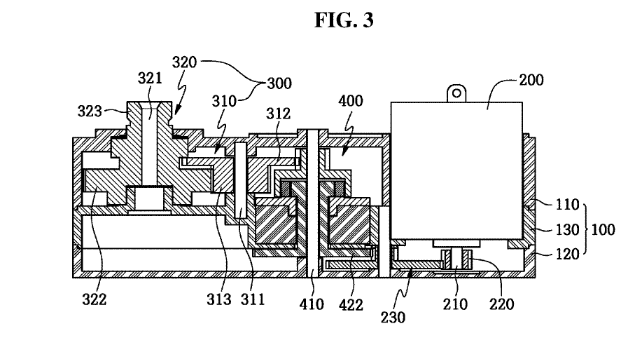

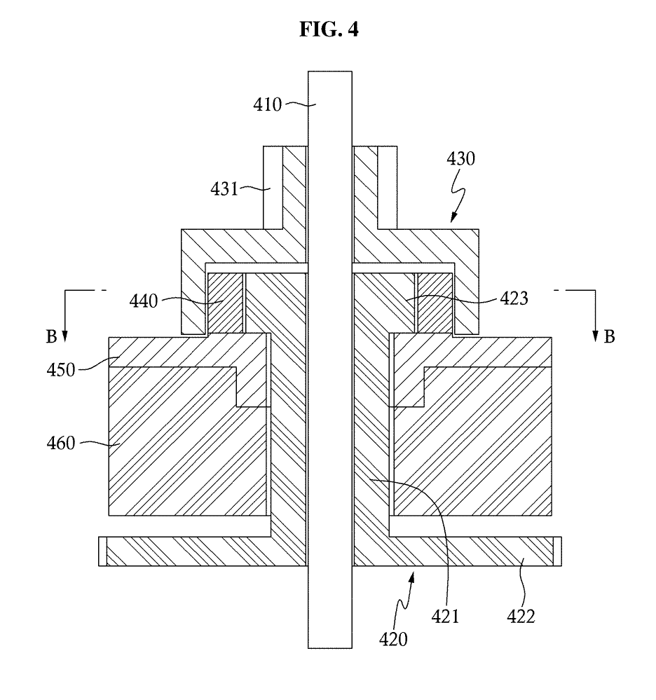

FIG. 1 is a perspective view of an assembly of a motor according to an example embodiment, FIG. 2 is an exploded perspective view of a motor according to an example embodiment, FIG. 3 is a cross-sectional view cut along line A-A of FIG. 1, and FIG. 4 is an enlarged cross-sectional view of a clutch unit according to an example embodiment.

Referring to FIGS. 1 to 4, a motor having a clutch function includes a housing 100, a driving unit 200 installed in the housing 100, a reduction gear unit 300 configured to reduce a rotational speed of the driving unit 200, and a clutch unit 400 connected between the driving unit 200 and the reduction gear unit 300 and configured to block power transmission.

The housing 100 forms an outer appearance of the motor as a structure configured to receive the driving unit 200, the reduction gear unit 300, and the clutch unit 400. The housing 100 includes an upper housing 110, a lower housing 120, and a middle housing 130.

The driving unit 200 is mounted to an upper right side of the middle housing 130, the reduction gear unit 300 is mounted to an upper left side of the middle housing 130, and the clutch unit 400 is mounted at an upper center of the middle housing 130. Upper portions and lower portions of the driving unit 200, the reduction gear unit 300, and the clutch unit 400 mounted to the middle housing 130 are received and thereby finished by the upper housing 110 and the lower housing 120.

The driving unit 200 acquires torque from electrical energy. For example, the driving unit 200 may be a motor that generates torque in response to electricity being applied. A driving unit shaft 210 is connected to a bottom of the driving unit 200. Also, a driving gear 220 is provided to the driving unit shaft 210 and configured to transmit the torque.

The reduction gear unit 300 is configured to reduce a rotational speed of the driving unit 200. The reduction gear unit 300 includes a first reduction gear 310 and a second reduction gear 320.

The first reduction gear 310 is configured as a spur gear that is provided to a first reduction gear shaft 311 vertically rotatably connected between the upper housing 110 and the middle housing 130. A first spur gear 312 is provided in an upper portion of the first reduction gear shaft 311 to engage with a driven pinion 431 of the clutch unit 400. A second spur gear 313 is provided in a lower portion of the first reduction gear shaft 311 to transmit the torque to the second reduction gear 320.

Each of the first spur gear 312 and the second spur gear 313 may be configured to have a different gear diameter and a different number of gears. For example, referring to FIG. 3, the first spur gear 312 may have a diameter greater than that of the second spur gear 313 and a number of first spur gears 312 may be greater than a number of second spur gears 313. However, it is provided as an example only. The diameter and the number for the first spur gear 312 and the second spur gear 313 may be appropriately modified to transmit the torque at an accelerated speed, a decelerated speed, or the same speed.

The second reduction gear 320 is configured as a spur gear that is provided to a second reduction gear shaft 321 vertically disposed in an upper portion of the middle housing 130. The second reduction gear 320 appropriately reduces the torque reduced at the first reduction gear 310 and outputs the appropriately reduced torque. Here, a third spur gear 322 is provided in a lower portion of the second reduction gear shaft 321 to engage with the second spur gear 313 of the first reduction gear 310. A fourth spur gear 323 is provided in an upper portion of the second reduction gear shaft 321 to output the torque to another component connected thereto. However, it is provided as an example only. Each gear may be appropriately modified as, for example, a helical gear to transmit a rotary motion.

The clutch unit 400 is provided between the driving unit 200 and the reduction gear unit 300 and configured to transmit or block power depending on necessity. The clutch unit 400 includes a clutch shaft 410, an inner race 420 having a drive pinion 422 and a clutch shell 423 rotatably provided to the clutch shaft 410, an outer race 430 having a driven pinion 431, a plurality of rollers 440 provided between the clutch shell 423 and the outer race 430, an armature 450 having a retainer 451, and a solenoid 460.

The clutch shaft 410 may be a central shaft of the clutch unit 400. The clutch shaft 410 is fastened to the housing 100 in such a manner that a top end of the clutch shaft 410 is connected to the upper housing 110 and a bottom end thereof is connected to the lower housing 120. The outer circumferential surface of the clutch shaft 410 has a circular cross-section such that the clutch shaft 410 may serve as a central shaft on which the clutch unit 400 rotates.

The inner race 420 includes a sleeve 421 rotatably provided to the clutch shaft 410, the drive pinion 422 provided in a lower portion of the sleeve 421 and configured to connect to the driving unit 200, and the clutch shell 423 provided in an upper portion of the sleeve 421 and configured to rotate with the drive pinion 422.

The sleeve 421 is in a cylindrical shape. Inner circumference of the sleeve 421 is provided to be rotatable relative to outer circumference of the clutch shaft 410.

The drive pinion 422 is integrally provided with the lower portion of the sleeve 421 and configured to connect to the driving gear 220 of the driving unit 200. The drive pinion 422 rotates the inner race 420 in response to rotation of the driving unit 200. Here, a gear unit 230 may be provided between the drive pinion 422 and the driving gear 220 for deceleration or acceleration.

However, it is provided as an example only. The sleeve 421 may include an upper sleeve and a lower sleeve such that the upper sleeve and the lower sleeve rotate with engagement therebetween.

The clutch shell 423 is integrally provided with the upper portion of the sleeve 421 and configured to rotate with the drive pinion 422.

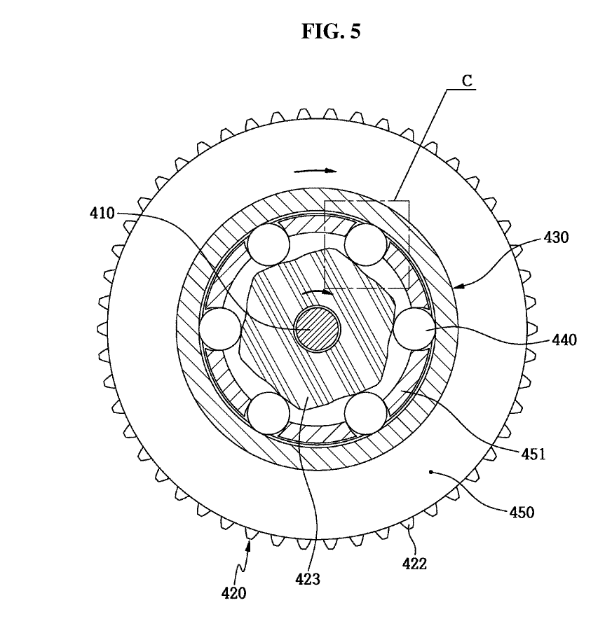

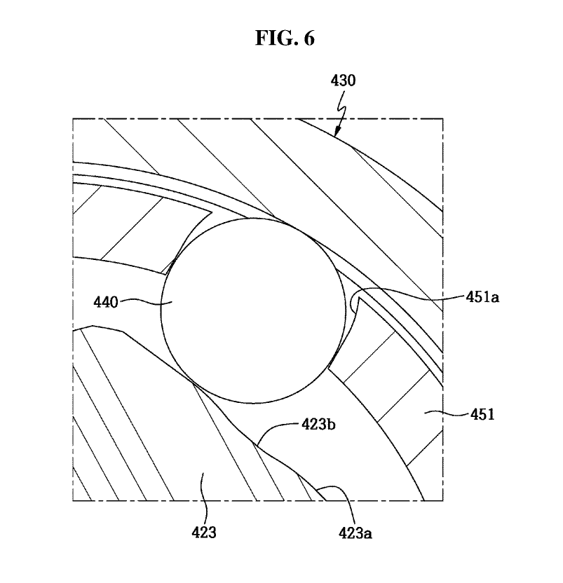

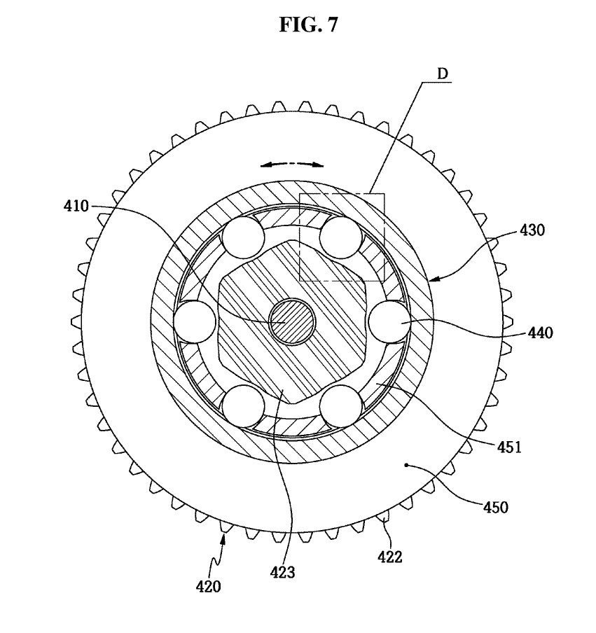

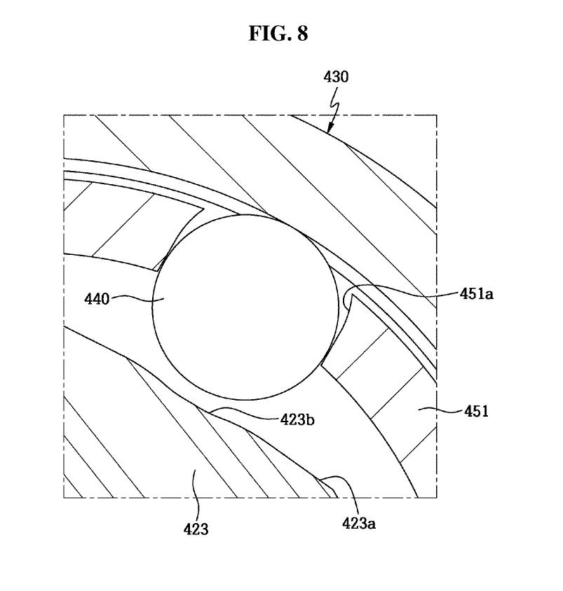

FIG. 5 is a cross-sectional view of a roller in a wedge state, cut along line B-B of FIG. 4, FIG. 6 is an enlarged view of a portion ‘C’ of FIG. 5 according to an example embodiment, FIG. 7 is a cross-sectional view of a roller in an idle state, cut along line B-B of FIG. 4 according to an example embodiment, and FIG. 8 is an enlarged view of a portion ‘D’ of FIG. 7 according to an example embodiment.

Referring to FIGS. 5 to 8, the clutch shell 423 is in a plate form in an approximately planar and polygonal shape to correspond to the plurality of rollers 440. A corner of the clutch shell 423 is curved to prevent a contact with the outer race 430. Also, the clutch shell 423 includes a polygonal contact surface 423a configured to contact the roller 440 and an inwardly curved surface 423b at the center of the contact surface 423a and configured to form a gap from the outer circumference of the roller 440. The gap between the curved surface 423b and the roller 440 may be enough for the roller 440 to enter into an idle state. Here, the idle state refers to a state in which the roller 440 freely rotates between the outer race 430 and the inner race 420 and transmission of torque from the outer race 430 to the inner race 420 by an external force is blocked.

Although it is illustrated that the corner of the clutch shell 423 is curved, it is provided as an example only. Also, although the curved surface 423b is illustrated to be curved, it is provided as an example only and the contact surface 423a may be in a flat surface form.

The outer race 430 includes circular inner surface to receive the clutch shell 423 and is rotatably provided in an upper portion of the clutch shaft 410. The driven pinion 431 is integrally provided in an upper portion of the outer race 430 and configured to rotate together therewith. The driven pinion 431 is connected to the reduction gear unit 300.

The plurality of rollers 440 are disposed at predetermined intervals in a circumferential direction between the clutch shell 423 and the inner surface of the outer race 430. The plurality of rollers 440 transmit torque generated in the clutch shell 423 to the outer race 430, or enter into an idle state and block transmission of the torque. For example, referring to FIG. 6, when the plurality of rollers 440 operate as a wedge between the clutch shell 423 and the outer race 430, the inner race 420 and the outer race 430 may integrally rotate.

On the contrary, referring to FIG. 8, when the plurality of rollers 440 are positioned on the curved surface 423b and enter into an idle state, torque being input from the outer race 430 to the inner race 420 by an external force may not be transmitted to the inner race 420.

The armature 450 is in an approximately disc form and rotatably provided relative to the outer circumference of the sleeve 421 of the inner race 420 to be adjacent to a bottom surface of the clutch shell 423. A retainer 451 in a ring shape is formed on the armature 450 to maintain an interval between the rollers 440 and to prevent separation of the roller 440. To this end, receiving grooves 451a are formed in the retainer 451 at the same interval to receive the rollers 440. Also, the armature 450 is a magnetic substance that reacts to a magnetic force. For example, the armature 450 may be a metal material that is pulled toward the solenoid 460 by a magnetic force of the solenoid 460, which is described below. However, it is provided as an example only and the armature 450 may be a permanent magnet that moves based on a polarity of the solenoid 460.

The solenoid 460 is inserted into the outer circumference of the sleeve 421 of the inner race 420 and thereby is fastened to the middle housing 130. The solenoid 460 is non-rotatably fastened to the middle housing 130. The sleeve 421 is rotatably connected to the inner circumference of the solenoid 460. Also, the solenoid 460 is provided to be adjacent to a bottom surface of the armature 450.

The solenoid 460 transits a torque transmission state of the plurality of rollers by controlling the rotation of the armature 450. Here, a state transition of the plurality of rollers refers to transition to a state in which the plurality of rollers operate as a wedge between the outer race and the clutch shell to transmit the torque or to enter into an idle state.

The solenoid 460 maintains the armature 450 to be in a non-resistance state at all times and the armature 450 rotates in response to rotation of the clutch shell 423. Here, the roller 440 is maintained in a self-rotatable state between the clutch shell 423 and the outer race 430. The solenoid 460 may generate resistance by friction or magnetic force by generating the magnetic force and by pulling the armature 450. In this case, frictional resistance increases between the solenoid 460 and the armature 450, and a rotational speed of the armature 450 decreases compared to that of the clutch shell 423. The armature 450 and the clutch shell 423 serve to connect or block between the inner race 420 and the outer race 430 by a difference between the rotational speeds.

An operation of the present disclosure configured as above will be described with reference to FIGS. 5 to 8. Initially, an operation that the torque of the driving unit 200 is transmitted to the reduction gear unit 300 through the clutch unit 400 will be described. The torque that is generated by driving of the driving unit 200 and rotates in one direction is transmitted to the drive pinion 422 of the inner race 420 through the gear unit 230 that engages with the driving gear 220. Through the torque transmitted to the inner race 420, the clutch shell 423 rotates with the drive pinion 422. Here, the clutch shell 423 pushes the roller 440 to rotate the armature 450. However, since the roller 440 is in an idle state, the torque is not transmitted to the outer race 430.

Here, the solenoid 460 generates the magnetic force and pulls the armature 450. In this case, resistance occurs between the armature 450 and the solenoid 460. The rotational speed of the armature 450 decreases due to the resistance and a speed difference between the armature 450 and the clutch shell 423 of the inner race 420 occurs. The clutch shell 423 outwardly pushes the roller 440 of which the speed is reduced by the armature 450, and the roller 440 operates as a wedge between the inner race 420 and the outer race 430 as illustrated in FIG. 5.

After this, generation of the magnetic force in the solenoid 460 is blocked and the armature 450 rotates in a non-resistance state. That is, the inner race 420 and the roller 440, and the armature 450 and the outer race 430 integrally rotate together. The inner race 420 and the outer race 430 rotate in the same direction.

The torque transmitted to the outer race 430 is transmitted to the reduction gear unit 300 through the driven pinion 431, and used to provide force feedback to a user using a wearable interface device.

The aforementioned description related to transmission of torque may be applied to a case of a reverse direction, and thus further description is omitted.

On the contrary, when the torque of the driving unit 200 is being transmitted to the reduction gear unit 300 through the clutch unit 400, the torque of the outer race 430 may be generated by the external force. Here, a rotational direction of the outer race 430 by the external force may be the same as that of the inner race 420.

Here, in response to occurrence of resistance in the armature 450 by applying electricity to the solenoid 460 at the same time of stopping driving of the driving unit 200, the armature 450 is decelerated. When the rotational speed of the outer race 430 increases compared to that of the armature 450 by the external force, the roller 440 enters into an idle state as illustrated in FIG. 8. Accordingly, the torque of the outer race 430 by the external force is not transmitted to the inner race 420. When generation of the magnetic force in the solenoid 460 is blocked, the armature 450 and the solenoid 460 enter into a non-resistance state again.

In this case, referring to FIG. 7, the rollers 440 maintained by the retainer 451 are in an idle state and coupling between the inner race 420 and the outer race 430 is blocked. Thus, transition to a free state is performed. In the motor having the clutch function, transited to the free state, an external force by a motion of the user is not transmitted through the clutch unit 400. That is, in the motor having the clutch function, transited to the free state, force feedback is not applied to the wearable interface device so that the user may freely move.

Also, when the torque of the driving unit 200 is being transmitted to the reduction gear unit 300 through the clutch unit 400, the magnetic force may be instantaneously applied to the solenoid 460 to control the armature 450 and to rotate the driving unit 200 in a reverse direction. In this case, the armature 450 temporarily decelerates and the clutch shell 423 rotates in the reverse direction, so that the plurality of rollers 440 enter into an idle state. Through the above process, transmission of torque between the inner race 420 and the outer race 430 is prevented and transition to the free state is performed. In this case, the torque transmission may be blocked regardless a rotational direction of the outer race 430.

However, it is provided as an example only. When the torque is being transmitted to the reduction gear unit 300 through the clutch unit 400, the torque of the outer race 430 greater than the torque of the inner race 420 may be generated by the external force. Here, the rotational speed of the outer race 430 increases compared to that of the inner race 420 and the plurality of rollers 440 enter into an idle state. Here, if the armature 450 is controlled, the driving unit 200 decelerates and an instant rotational speed difference with the outer race 430 occurs. Accordingly, the plurality of rollers 440 may further easily enter into the idle state.

When the driving unit 200 stops in a state in which the outer race 430 and the inner race 420 are connected through the clutch unit 400, the outer race 430 may rotate by the external state with the driving unit 200 being in the stop state. Here, in the wearable interface device, load for rotating the stopped driving unit 200 may operate as force feedback.

The above case may be possible when the torque of the outer race 430 by the external force is generated in a direction in which the roller 440 is separate from the curved surface 423b so that the roller 440 may operate as a wedge. The motor according to the example embodiment may be configured to adjust rotational directions of the solenoid 460 and the driving unit 200 to change the direction in which the roller 440 is separate from the curved surface 423b so that the roller 440 may operate as the wedge based on a rotational direction of the outer race 430 by the external force.

The motor having the clutch function according to the example embodiment may be configured to implement a state in which the driving unit 200 operates, the torque is transmitted to the outer race 430, and force feedback is provided to the user by the torque of the driving unit 200, a state in which the driving unit 200 stops, the roller 440 operates as a wedge between the outer race 430 and the inner race 420, and force feedback for manually rotating the driving unit 200 is provided to the user, and a free state in which the torque of the outer race 430 is not transmitted to the inner race 420. Also, in the free state, the user does not rotate a component between the driving unit 200 and the clutch unit 400. Accordingly, in the free state, the user may control the wearable interface device with a further small force in a state which the force feedback for manually rotating the driving unit 200 is provided to the user in the free state. That is, the user may perform manipulation with a minimum magnitude of force.

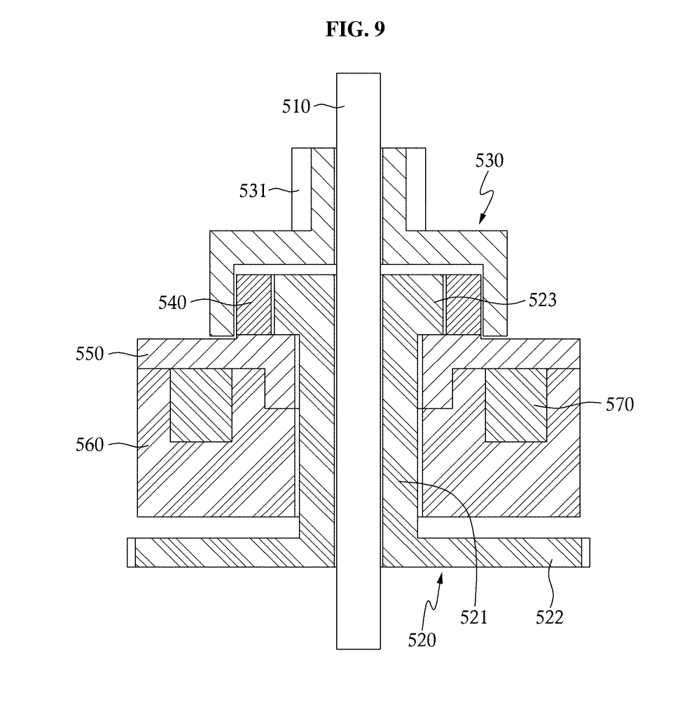

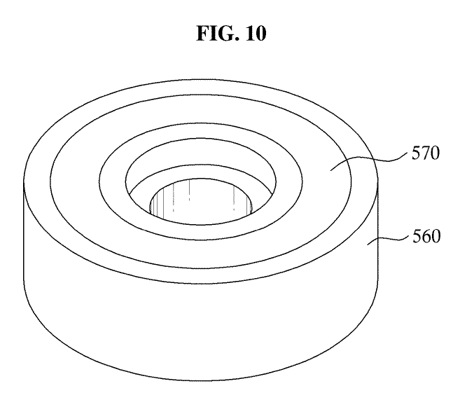

Hereinafter, a motor having a clutch function according to another example embodiment will be described with reference to FIGS. 9 and 10. A difference between the motor having the clutch function according to the example embodiment of FIGS. 9 and 10 and the motor according to the example embodiment of FIGS. 1 to 8 lies in a permanent magnet 570 provided to a solenoid 560. Description is generally made based on the difference and description related to like elements is omitted here. FIG. 9 is an enlarged cross-sectional view of a clutch unit according to another example embodiment, and FIG. 10 is an enlarged perspective view of a solenoid according to another example embodiment.

Referring to FIGS. 9 and 10, a clutch unit 500 includes a clutch shaft 510, an inner race 520 having a drive pinion 522 and a clutch shell 523 rotatably provided to the clutch shaft 510, an outer race 530 having a driven pinion 531, a plurality of rollers 540 provided between the clutch shell 523 and the outer race 530, an armature 550 having a retainer 551, the solenoid 560, and the permanent magnet 570.

The permanent magnet 570 inserts into the solenoid 560 on a surface on which the armature 550 is present. For example, the permanent magnet 570 is in a ring shape and inserts into the solenoid 560 on the surface on which the armature 550 is present. However, it is provided as an example only and a plurality of permanent magnets 570, each in a cylindrical shape, may be radially provided along the circumference of the solenoid 560.

A diameter of the permanent magnet 570 may be less than that of outer circumference of the solenoid 560 and the armature 550. Also, a top end surface of the permanent magnet 570 may be formed at a height at which the permanent magnet 570 is in contact with the armature 550.

However, it is provided as an example only. The top end surface of the permanent magnet 570 may be formed at a height less than the surface of the solenoid 560 on which the armature 550 is present. In this case, resistance may occur due to a contact between the solenoid 560 and the armature 550.

The resistance occurs in such a manner that the permanent magnet 570 generates a magnetic force with the armature 550 and pulls the armature 550. Here, the permanent magnet 570 has the magnetic force with which the roller 540 may operate as a wedge. That is, the permanent magnet 570 pulls the armature 550 to rotate the driving unit 200 and, at this instant moment, a speed difference between the armature 550 and the clutch shell 523 instantaneously occurs. Here, the roller 540 may operate as a wedge between the clutch shell 523 and the outer race 530. Here, the permanent magnet 570 is configured to have the magnetic force so that resistance with the armature 550 is less than torque of the driving unit 200, and thus the armature 550, the inner race 520, and the outer race 530 may rotate together.

The permanent magnet 570 enables the roller 540 to operate as the wedge without operating the solenoid 560 and may transmit the torque of the inner race 520 to the outer race 530. When the solenoid 560 operates, it may further strengthen a wedge operation of the roller 540.

A process of making the roller 540 enter into an idle state and a process of generating load by resistance of the solenoid 560 and the armature 550 include the same components described above with the example embodiment, and thus further description is omitted.

Although a number of example embodiments have been described above, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. A motor used for wearable interface devices, the motor comprising:
a driving unit;
a reduction gear unit configured to reduce a rotational speed of the driving unit; and
a clutch unit connected between the driving unit and the reduction gear unit and configured to selectively block power transmission therebetween,
wherein the clutch unit comprises:
an inner race connected to the driving unit and having a clutch shell;
an outer race configured to output a torque of the clutch shell;
a plurality of rollers provided in a circumferential direction between the clutch shell and the outer race, and configured to transmit the torque;
an armature configured to rotate with maintaining an interval between the plurality of rollers; and
a solenoid configured to block the torque input from the outer race to the inner race by controlling the rotation of the armature.

2. The motor of claim 1, wherein the inner race comprises a drive pinion configured to connect to the driving unit, and
the outer race comprises a driven pinion configured to connect to the reduction gear unit.

3. The motor of claim 1, wherein the inner race comprises:
a sleeve rotatably provided along outer circumference of a clutch shaft fastened to a housing configured to receive the clutch unit;
the clutch shell configured to rotate with a drive pinion that is provided on one side of the sleeve and configured to connect to the driving unit and a drive pinion that is provided on another side of the sleeve,
the armature is rotatably provided along outer circumference of the sleeve to be adjacent to the clutch shell, and
the solenoid is configured to insert into the outer circumference of the sleeve to be adjacent to the armature and to fasten to the housing.

4. The motor of claim 1, wherein the clutch shell is in a polygonal plate shape having a contact surface to correspond to and contact the plurality of rollers, and
the contact surface comprises a curved surface that is curved inward to form a gap with outer circumference of the roller.

5. The motor of claim 1, wherein the armature further comprises a retainer configured to maintain the interval between the plurality of rollers.

6. The motor of claim 1, wherein the clutch unit further comprises:
a permanent magnet provided to the solenoid and configured to change a torque transmission state of the plurality of rollers to transmit the torque to the outer race by controlling the rotation of the armature in response to initially driving the driving unit.

7. A motor used for wearable interface devices, the motor comprising:
a driving unit;
a reduction gear unit configured to reduce a rotational speed of the driving unit; and
a clutch unit having an armature to be connected between the driving unit and the reduction gear unit and to selectively block power transmission therebetween,
wherein, when a torque input to the clutch unit through the reduction gear unit occurs, the torque input to the clutch unit through the reduction gear unit is blocked by controlling a torque of the armature.

8. The motor of claim 7, wherein the torque input to the clutch unit through the reduction gear unit is blocked by suspending the driving unit at the same time of controlling the torque of the armature.

9. The motor of claim 7, wherein the torque input to the clutch unit through the reduction gear unit is blocked by reversely rotating the driving unit at the same time of controlling the torque of the armature.

10. The motor of claim 7, wherein the clutch unit comprises:
an inner race connected to the driving unit and having a clutch shell;
an outer race configured to output a torque of the clutch shell;
a plurality of rollers provided in a circumferential direction between the clutch shell and the outer race, and configured to transmit the torque;
the armature configured to rotate with maintaining an interval between the plurality of rollers; and
a solenoid configured to change a torque transmission state of the plurality of rollers by controlling the rotation of the armature.

11. The motor of claim 10, wherein the inner race comprises a drive pinion configured to connect to the driving unit, and
the outer race comprises a driven pinion configured to connect to the reduction gear unit.

12. The motor of claim 10, wherein the inner race comprises:
a sleeve rotatably provided along outer circumference of a clutch shaft fastened to a housing configured to receive the clutch unit; and
a clutch shell configured to rotate with a drive pinion that is provided on one side of the sleeve and configured to connect to the driving unit and a drive pinion that is provided on another side of the sleeve,
the armature is rotatably provided along outer circumference of the sleeve to be adjacent to the clutch shell, and
the solenoid is configured to insert into the outer circumference of the sleeve to be adjacent to the armature and to fasten to the housing.

13. The motor of claim 10, wherein the clutch shell is in a polygonal plate shape having a contact surface to correspond to and contact the plurality of rollers, and
the contact surface comprises a curved surface that is curved inward to form a gap with outer circumference of the roller.

14. The motor of claim 10, wherein the armature further comprises a retainer configured to maintain the interval between the plurality of rollers.

15. The motor of claim 10, wherein the clutch unit further comprises:
a permanent magnet provided to the solenoid and configured to change a torque transmission state of the plurality of rollers to transmit the torque to the outer race by controlling the rotation of the armature in response to initially driving the driving unit.
